(19) United States
(12) Patent Application Publication
(10) Pub. No.: US 2003/0172267 A1
(43) Pub. Date: Sep. 11, 2003

(54) Shifting line of replaceable codes for authenticating identities in, and securing of, a remote communication situation

(76) Inventor: Yishay Gershon Yosef Gabrieli, Ramat-Gan (IL)

Correspondence Address: YISHAY GERSHON YOSEF GABRIELI, P O B 9957, RAMAT-GAN, 52111, IL

(21) Appl. No.: 09/917,737

(22) Filed: Jul. 31, 2001

Related U.S. Application Data
(60) Provisional application No. 60/222,912, filed on Aug. 4, 2000.

(51) Int. Cl. H04L 9/00

(52) U.S. Cl. 713/168; 713/201

(57) ABSTRACT

Method to authenticate identification between two remote entities that had for once performed a direct contact and wishes to conduct later on an indirect repetitive communication over a public media (such as an electronic, electromagnetic, or sonic media) that is both easy to operate, highly strong, and produces an automatic confirmation of all the previous connections, and provides a base for encryptions—all in one action.

### BACKGROUND OF THE INVENTION

In a situation where two entities communicate with each other, there is sometimes a need of one entity to authenticate the identity of the other.

Natural communication holds a wide range of means to authenticate the entity that you are in contact with. A location oriented authentication (this is the bank manager's room, so I acknowledge the guy in the big chair to be the bank manager as he claims to be). Natural biometric (her voice, his figure, the smell, etc.). A history match (he came in the time they said the technician would come? He knows who ordered him? He knows how to fix the machine? These are pieces of information that confirm that he has the history of the technician we asked for, so I accept his saying so.)

A remote communication that is conducted over a public media such as an electronic or electromagnetic media, especially a digitized one, is characterized in a total derogation of all of the natural means of authentication.

For such communication, when at least one of the sides is a computing machine, the preferred (and maybe the only) method to authenticate is through receiving information from the other side and checking it either by a pre-agreed process, or by a trusted third party.

The increasing dependency on remote communication for passing sensitive private commitments using public media has created a need for reliable, easy-to-use authentication methods (i.e. commitment to secrecy in passing medical data, or a bank committed to integrity and secrecy).

The authentication process is a combination of three parameters that sometimes are too obvious to be noticed: you need to create uniqueness to each entity, you need that uniqueness to be recognizable, and you need that uniqueness to be non duplicable.

The existing methods are attending to less than all three parameters. A password is the least authenticating of all methods. A biometric authentication in remote communication is basically passing bigger passwords, carrying almost all of the simple password defaults. The most popular PKI (Public Key Infrastructure) is a beautiful, mathematically based system that creates very strong encryption codes but uniqueness is not a structured value in it—the PKI system is agreeable with more than one duplication of an entity using the same code, and the strength of the PKI is basically measured not by the strength of its keys, but by the strength of the lockers that contain the keys. Moreover, the PKI method is based on a single copy of a private root key that requires Fort Knox security measures for guarding, and the issuing firm has to guard its uniqueness literally for life. A rolling key method, on the other hand, provides infrastructure uniqueness, but it still provides poor protection from milking out its next code, and weaker base for encryption.

### BRIEF DESCRIPTIONS OF THE INVENTION

The method presented herewith is based upon a digital optimization of the natural authenticating through history, and constantly manipulates that history.

The system is built upon a fixed length line of confidential codes (“the inner shifting line”) that exists in parallel in the hands of both entities.

In the end of the process of authentication of each contact, the two entities write the sequential number of this contact, and one entity provides to both entities a unique code for this contact—a code that both entities register as the top code in the line.

In this way, a unique private memory is created; combined from these two parallel lines of inner codes—a memory that is shared only by these two entities.

The authentication process is executed through these two inner shifting lines.

In the beginning of the contact, the two entities identify themselves to each other, and then they initiate the process of authenticating each other.

The first entity asks for the bottom code (the oldest key), verifies it, and the two entities erase it from their inner shifting line. This is to exploit the code that must be deleted anyhow in order to keep the length of the line fixed.

The other entity asks for one code of one random place in the inner shifting line, verifies it, and provides to both entities a new code to replace it (refresh it) in both entities inner shifting line.

(Option) The first entity repeats the process in another random place of the inner shifting line.

The other entity asks for the top code of the inner shifting line (the code that was created in the previous contact), verifies it, and provides to both entities a new code to replace it (refresh it) in the two entities' inner shifting line. The specification of the first code is to assure the integrity of the line from the last communication.

Any non-matched code sets a faked identity warning.

If a match exists through all the process, the authentication is completed. The two entities write the sequential number of this contact, and one entity provides to both entities the unique code for this contact—the entities are free to exchange secure information.

The inner shifting line can alternatively use the random code to provide it as a “random synchronized key” for encrypting messages between the entities. In this option, one entity notifies the other only of the place of the code to be used in the current message.

### BRIEF DESCRIPTION OF THE DRAWINGS

FIG. 1—an overall view of the system

FIG. 2a-FIG. 2c—the structure of the inner metamorphic ring.

FIG. 3a-FIG. 3g—the process for establishing a secure authenticated communication.

FIG. 4—the conclusion of the metamorphose process on the ring.

FIG. 5a-FIG. 5b—flowchart from the points of view of both entities.

### DETAILED DESCRIPTION OF THE PREFERRED EMBODIMENT

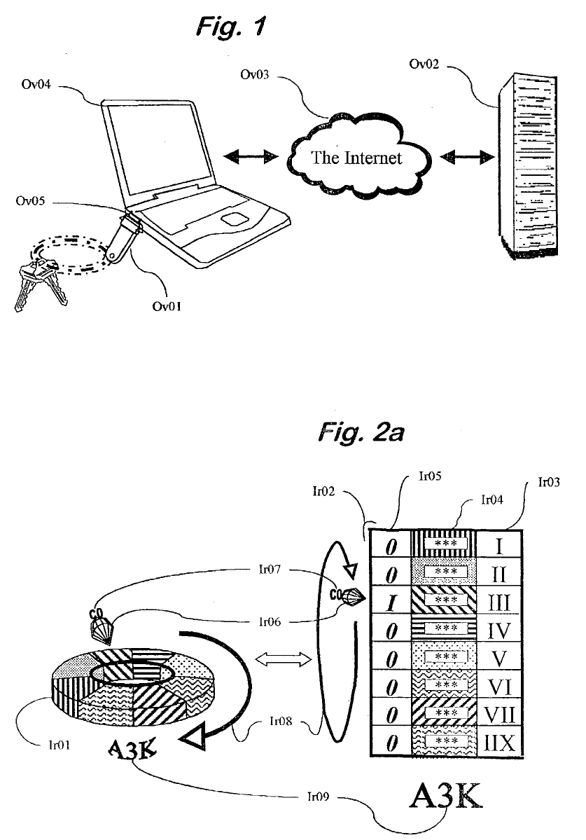

FIG. 1 An overall view of the system involved in establishing a virtual private network (VPN): a secure, private and authenticated communication over the internet (Ov04), between a server of a firm (Ov02), and a remote person that works from his laptop (Ov03) and carries a token (Ov01) that is plugged to the laptop by a USB connection (Ov05), and carries inside it an IC processor and a flash memory.

The system presented herewith is based on the designing of the codes line in a loop that will be referred here as “The inner metamorphic ring”, or “The inner ring”.

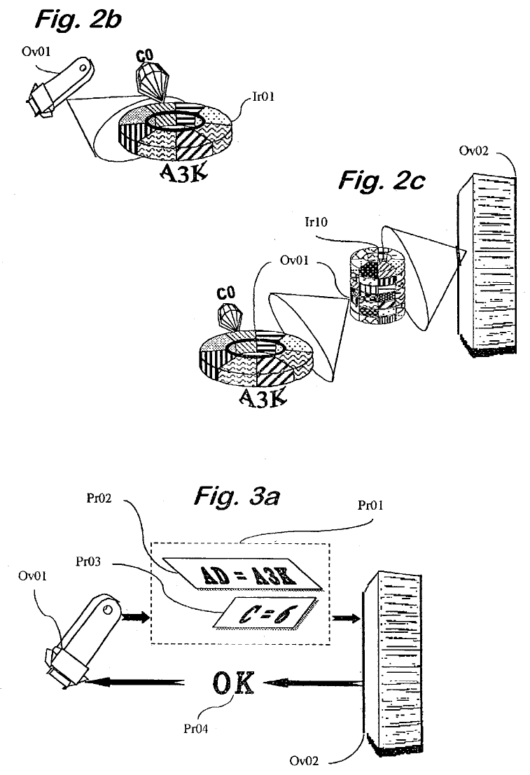

FIG. 2a The inner metamorphic ring (Ir01) is based on a relational table, as in SQL format (Ir02), and holds 3 columns—a fixed index column (Ir03) whose cell values determine the order of the rows, a column (Ir04) whose cells each contain a different short code (represented here by the different textures of the cells), and a column (Ir05)whose cells accept only a binary I/O value, under the condition that one, and only one of its cells must contain the I value (“radio buttons”). The I value is represented in the drawings as “a stone” (Ir06), and the code in its row is declared to be the newest, referred here as cell No. 0 or C0 (Ir07).Calls following it are counted as C1, C2, C3 . . . and so forth for all the rows.

Each communication renews the next row code to be declared as the newest, so the “stone” is shifted (Ir08) to the next row one step at a time.

Each established relationship has its unique table that carries its unique ID. The ID of this relation is A3K (Ir09).

FIG. 2b the token (Ov01) contains the ring (Ir01) in its flash memory. These drawings demonstrate a ring in the size of eight rows; in reality it will include at least several dozens of rows.

FIG. 2c the server (Ir01) from its side keeps in its memory a packet of rings (Ir10). For each entity that it relates to, it keeps en exact copy of its ring (Ir01), including the position of the stone—a copy that it draws out (Ir06) whenever the entity contacts it.

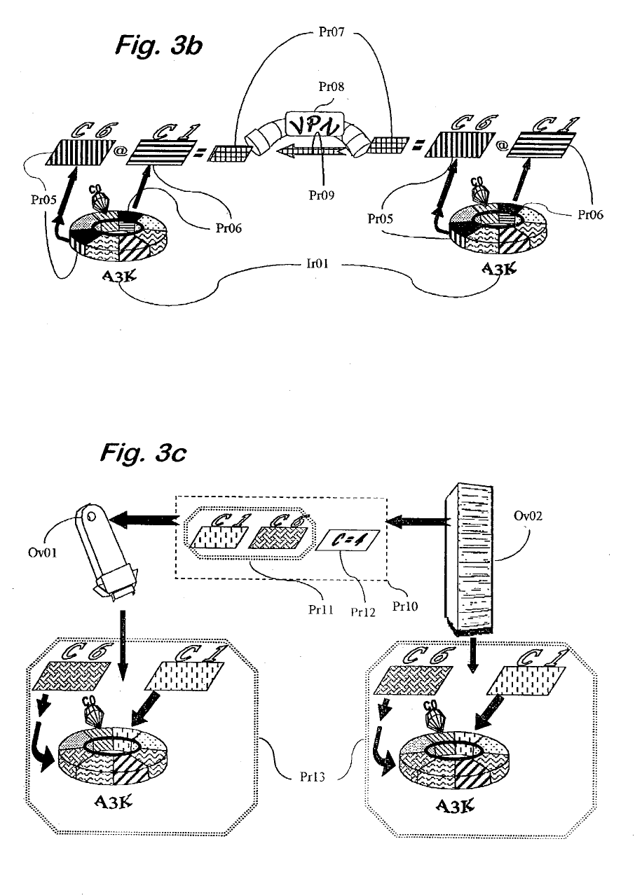

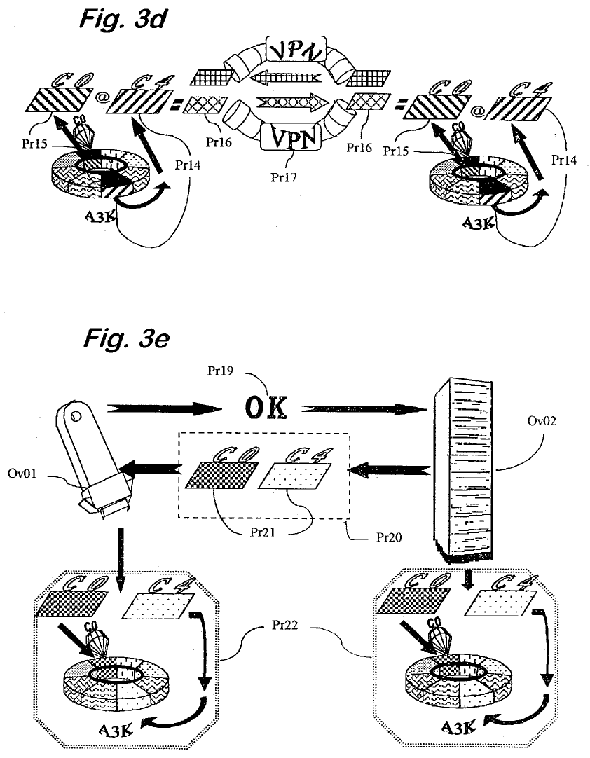

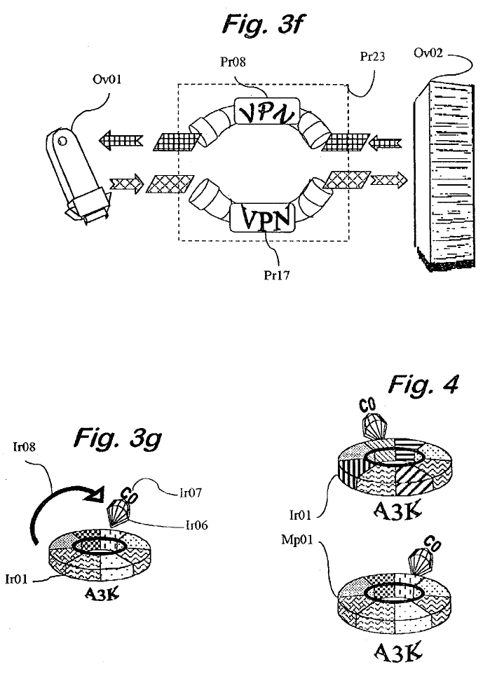

FIG. 3a the process begins with a request of the token (Ov01) to contact the server (Ov02). The request is made by sending a packet (Pr01) of plain information that contains the ID (Pr02) of the ring and a random number between 2-7 as a No. 1 pointer to point out a random cell (Pr03) in the ring (In the case that is presented in the drawings it is c6 the 6th cell from the stone). This data is the only un-encrypted data that will pass in the process.

The server draws out the matching ring and confirms (Pr04) to the token to continue with the process.

FIG. 3b both the server and the token are drawing the same two codes from their rings (Ir01). The code of the random line that was pointed out by the pointer No. 1 (Ir01), and (Pr06) the code that is declared to be the oldest one (C1—the right cell next to the stone), and combine them to a seed code (Pr07) that will be used for one-way encryption (Pr08), only for incoming data (a VPN tunnel) from the server to the token—The server is only encrypted by it, and the token is only decrypted by the same (Pr09).

FIG. 3c Through the VPN tunnel that has been established, the server (Ov02) sends to the token (Ov01) the No. 1 encrypted package (Pr10) including two refilling codes to replace the two codes that have been used to establish the tunnel (Pr11), and a pointer No. 2 (Pr12)—a random number between 2-7 that is not equal to pointer No. 1 (In the case that is presented in the drawings it is c4 the 4th cell from the stone). The two sides replace the two used codes with the new ones, thus starting the metamorphosis of the ring (Pr13) configuration.

FIG. 3d Both the server and the token are again drawing another two codes from their rings. The code of the random line that was pointed out by the pointer No. 2 (Pr14), and the code (PR15) that is declared to be the newest one (C0—the cell under to the stone), and combine them to a seed code (Pr16) that will be used for one-way encryption (Pr17), only for outgoing data (a VPN tunnel) from the token to the server—The token is only encrypted by it, and the server is only decrypted by the same (Pr18).

FIG. 3e Through the outgoing VPN tunnel (Pr18), the token (Ov01) sends to the server (Ov02) an OK confirmation to proceed with the process, and the server returns an encrypted package No. 2 (Pr20) that contains two additional refilling codes (Pr21), to replace the two codes that have been used to establish the second tunnel. The two sides (Pr22) replace the two used codes with the new ones, thus proceeding with the metamorphosis of the ring configuration.

FIG. 3f After establishing the two tunnels (Pr23) for both incoming (Pr08) and outgoing (Pr17) communication between the token (Ov01) and the server (Ov02), the two sides can now conduct a secured authenticated communication between themselves.

FIG. 3g At the end of the communication, the two sides are abolishing the VPN tunnels among them, and are shifting (Ir08) the stone (Ir06) one step to the right, so C0 became C8, C1 is declared as the newest (Ir07) code in the ring (Ir01), and becomes C0 while all the other cells loose one degree in their order.

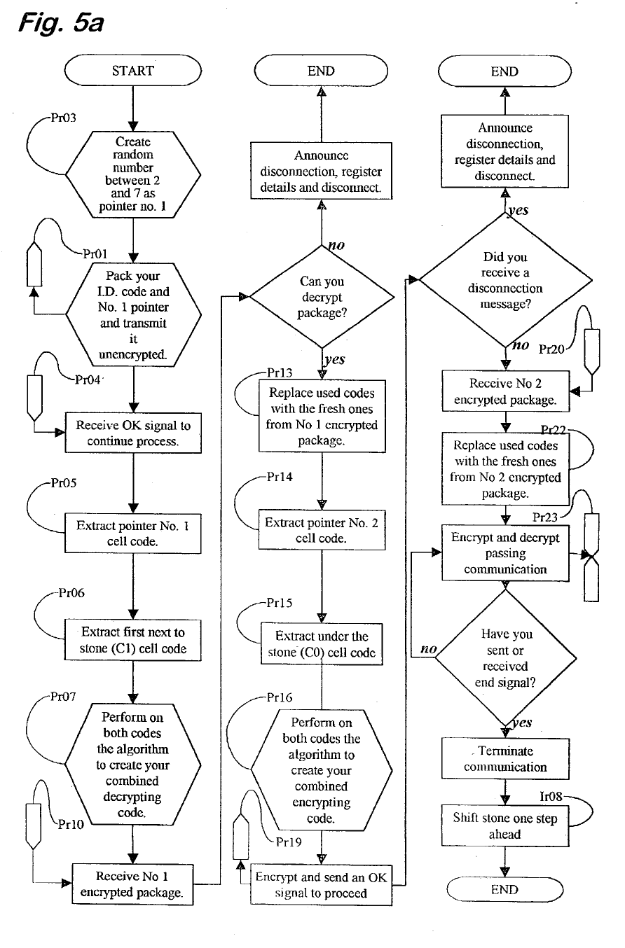

FIG. 4 The metamorphic process has begun in one configuration of the ring (Ir01) with which we have started the communication, and now this configuration has gone both from the server and the token. If someone indeed had managed to fake the ring prior to this communication, and he was the one that conducted this contact, this configuration would still have been kept in the token, and the next time that the token's entity would have tried to establish communication, the failure to communicate would both automatically alert the problem and halt it.

At the end of the process (Po01) the codes of the ring have been only partly changed, some in random selection, and some in predefined selection, but the shifting of the stone has completely altered the ring configuration for the next communication.

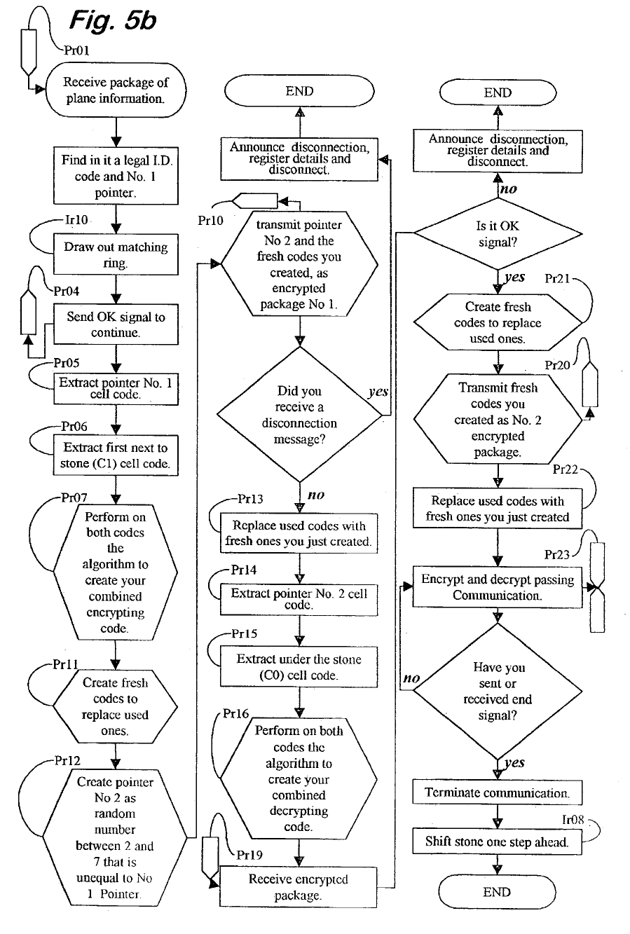

FIG. 5a is a flowchart from the token's point of view.

FIG. 5b is a flowchart from the server's point of view.

The authentication process reveals a minimal profile of the chain of codes by completely redesigning the ring, and thus the inner metamorphic ring system insures that not the ring programmer, and not even the ring holder can create a lasting existence for more than one copy for each relationship.

A single eavesdropping submits only one known code out of four needed to establish the next communication (only the code that is declared to be the newest).

To create a duplicate for the ring, an eavesdropper would have to crack every communication of its history (the number of the cells in the inner ring) from wherever they were made.

The cross reference is built to prevent an impostor server.

The need to change every used code prevents the possibility of “milking out” one of the sides.

Authenticating proof of the last connection proves all the previous contacts.

I claim on a:

1. Method and procedure to be used between two remote entities that had for once performed a direct contact, and wishes to authenticate each other's identity afterwards in a repetitive indirect communication between themselves via an unsecured electronic, electromagnetic or sonic media, and:
are using for that purpose a system that is built upon two exact copies of a fixed length line of cells, that exists in parallel in the hands of both entities—one copy per each entity, and:
the order of the cells in the line can be reconfigured, and:
the reconfiguration of the order of the cells, whenever it is performed, is done simultaneously at the same time, and in the same order, in such a manner that the two lines remain identical at all times, and
each cell in the line can be identified by its position in the line, and:
each cell carries in it a code that is replaced every time it has been used in a way that:
both sets must replace the same codes in the same cells in the line at the same time, so that the two sets of codes in the cells of the lines remain identical at all times, and:
the initial loading of the codes is performed in the initial direct contact of the entities, and:
the actions that are preformed on the set, in order to provide the entity authentication include:
an exposure of different cells for each connection, and:
submitting the exposed calls' codes by the authenticating providing side to the authentication requesting side as an authentication prove, while:
the selection of at least one cell that will be exposed is made by a random point out of the authentication asking side, and:
replacing in both copies of the line each code that has been exposed by a newly created code for the next communication, and:
rearranging the order of the cells in both copies of the line for the next communication.

2. Method according to claim 1 wherein the arranging of the cells is in a loop as a ring.

3. Method according to claim 1 wherein instead of arranging the cells in line, they are arranged in more than one dimension grid, so that the position of each cell is determinate by more than one parameter.

4. Method according to claim 1 wherein the codes that have been exposed can be used as a base to create an encrypted communication

5. Method according to claim 1 wherein the authentication is performed by submitting a combination that has been created out of more than one code, in such a way that the original codes can not be recognized in the transition.

6. Method according to claim 4 wherein the combination that has been created out of more than one code can be used as a base to create an encrypted communication.

7. Method according to claim 3 and 5 wherein the authentication is performed by passing only an agreed message, where its correct decryption confirms the identity of the sender.

8. Method to double the strength of any encrypting method by using different codes to separate between the incoming encrypting code and the outgoing encrypting code, in remote encrypted communication.
